(19) United States
(12) Patent Application Publication
(10) Pub. No.: US 2007/0256275 A1
(43) Pub. Date: Nov. 8, 2007

(54) Upper Door Closer

(76) Inventor: Bernd Winkler, Breckerfeld (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/660,178

(22) PCT Filed: Aug. 18, 2005
(86) PCT No.: PCT/EP05/08938

§ 371 Date: Feb. 14, 2007

(30) Foreign Application Priority Data
Aug. 25, 2004 (DE) 10 2004 041 358.4

(51) Int. Cl. E05F 3/10

(52) U.S. Cl. 16/53

(57) ABSTRACT

The invention relates to an overhead door closer. For reducing the width of the overhead door closer including the casing, it is proposed that the overhead door closer has two compression springs, which are disposed one inside the other, that the spring supporting member and the damping piston have an anti-rotation means in relation to the cam disc and in that the housing wall has a reduced cross-section on both sides of the longitudinal axis such that a substantially planar surface is formed on the outside.

The invention relates to an overhead door closer with a closer shaft, which is operable in the closing direction by means of an assembly of springs.

Usually the overhead door closer is attached at a door frame, at a door or at a wall, an actuating arm at one end being attached at the closer shaft of the overhead door closer, and the other end with a slide member being maintained in a guiding rail or slide channel, which is attached at the door. As an alternative and depending on the situation, it is possible to attach the overhead door closer at the door and the guiding rail or slide channel at the door frame or at the wall. In order to create a visually harmonious design, the manufacturers strive for building the overhead door closer as small as possible, and for adapting it to the dimensions of the guiding rail or slide channel, which are even much smaller. As the forces and torque moments arising through the door need to be absorbed by mechanical and/or hydraulic components, due to spatial extensions of e.g. pistons and cylinders or springs, it was impossible to stay below certain dimensions, in order to respect the requirements set by the standard. Therefore, for more than 15 years, a width of about 45 mm and a height of about 60 mm are the absolute limit when dimensioning overhead door closers of the size EN 2-4 (closing moment of 13 to 36 Nm at 0° to 4°), the length having been always variable on account of several drive concepts and geometrical suspension points at the door.

An overhead door closer has been known from DE 40 38 720 A1, the drive of which, by using a symmetrical cam disc and a special mounting plate, can be optionally used for right hinged or left hinged doors without requiring any modification or adaptation. The use of the symmetrical cam disc achieves the same torque characteristics and also the same closing attenuation in both directions of rotation.

A further development of this overhead door closer is described in DE 40 41 824 C1, wherein an anti-rotation means is indicated between the damping piston and the spring supporting member.

It is the object of the invention to develop an inexpensive overhead door closer, which has more compact dimensions than those of the state of the art.

The problem of the invention is solved with an overhead door closer according to the features of claim 1.

The invention takes advantage of the know-how to date in the field of overhead door closers and combines a plurality of structural improvements in order to achieve the reduced dimensions. In particular on account of very extensive studies of mechanical strength, it was found out that the limiting factor for the forces is not the housing cross-section or the bearing pressure on the cam disc, but the support of the spring, which, due to the high axial force, tends to force the support together with the thread out of the housing and thus to shear off the thread. By changing over to a fine thread, which, compared to a metric regular thread, has a tensile yield strength of about 10% more, in conjunction with a longer thread, an important weak point in dimensioning the housing could be avoided. The study on mechanical strength showed furthermore that the until now allegedly too important torque moment, induced into the housing via the rod assembly onto the driver square end, was induced for the major part onto the attachment points of the overhead door closer at the door, the door frame or the wall. The arising bending moment and the warping of the housing are thus considerably smaller than it was supposed until now. As a result, the wall thickness of the housing could be reduced altogether for the substantially tubular shape with a circular ring-shaped cross-section of the housing. At the same time, along the longitudinal axis parallel to the wall attachment or the door attachment, the housing was routed off, i.e. a segment of a circle was removed from both sides across the cross-section of the housing, such that the housing wall has a substantially plane surface in this area.

Another reduction of the cross-section is realized, if two springs, instead of one until now, are used, a small spring being spatially integral with the large spring. By adding up the spring forces, the large spring may have a slightly smaller exterior diameter, which in turn influences the diameter of the housing. Another optimization is realized, if the spring support member and the damping piston are protected against rotation in relation to the cam disc, because quite some spring energy is lost through this rotation. Thereby, the diameter of the large spring could be reduced again. By adding up these partially known individual measures, in conjunction with the findings on the actually arising forces, for a door closer size EN 2-4, the width of the overhead door drive including the casing could be reduced from 47 mm to 38 mm or even 36 mm, preferably 37 mm, and the height from 65 mm to 50 mm or even 48 mm, preferably 49 mm. In this case, the width of the housing of the drive was reduced from 42 mm to 33 mm or even 31 mm, preferably 32 mm.

In this case, the dimensions vary depending on the selected standards, materials and embodiments.

Another advantageous embodiment is the attachment of the overhead door closer at a mounting bracket, which can be mounted, directly or indirectly to the door frame or to the wall by means of a mounting plate to the door. The mounting bracket offers the advantage of an improved accessibility, when compared to other housing or casing options. The attachment points and the openings for the driver square end at the mounting bracket are configured such that an optional mounting to a right hinged or left hinged door can be carried out with one overhead door closer and one mounting bracket. The mounting bracket is laterally closed with end caps. The casing is just slid onto the mounting bracket with the overhead door closer already mounted in place. The casing is likewise embodied for a possible use with right hinged or left hinged doors, because, corresponding to the opening for the driver square end, apertures are provided, which can be produced by breaking off the covering clips. Thus, one overhead door closer, one bracket and one casing allow for optionally equip a right hinged or a left hinged door.

Hereinafter, the invention shall be explained based on the drawings of one diagrammatically illustrated exemplary embodiment, in which:

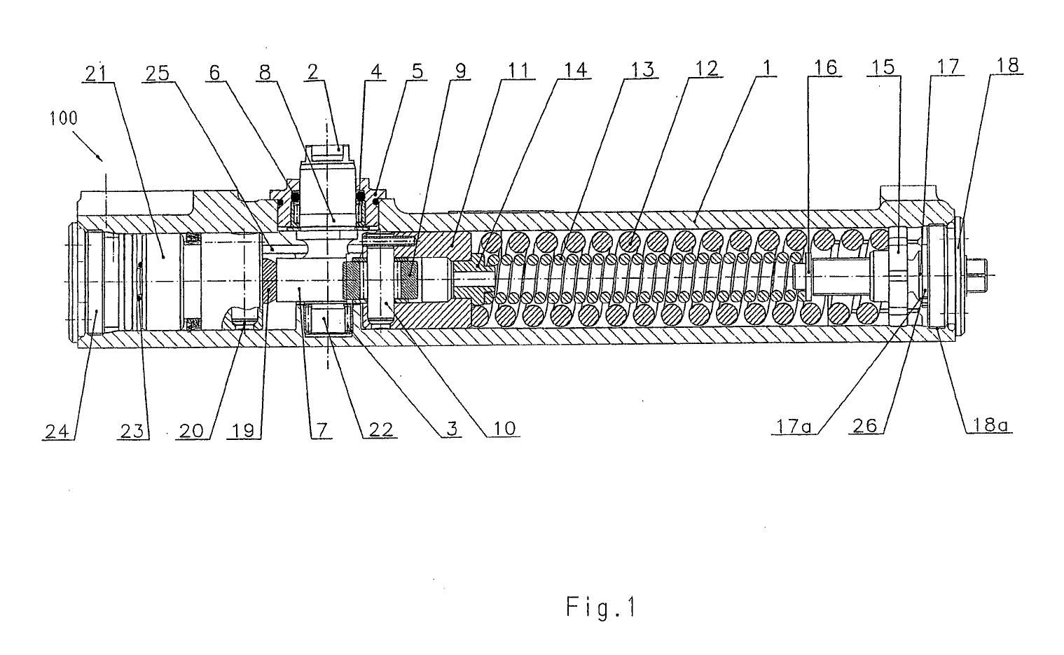

FIG. 1 shows a longitudinal section through an overhead door closer,

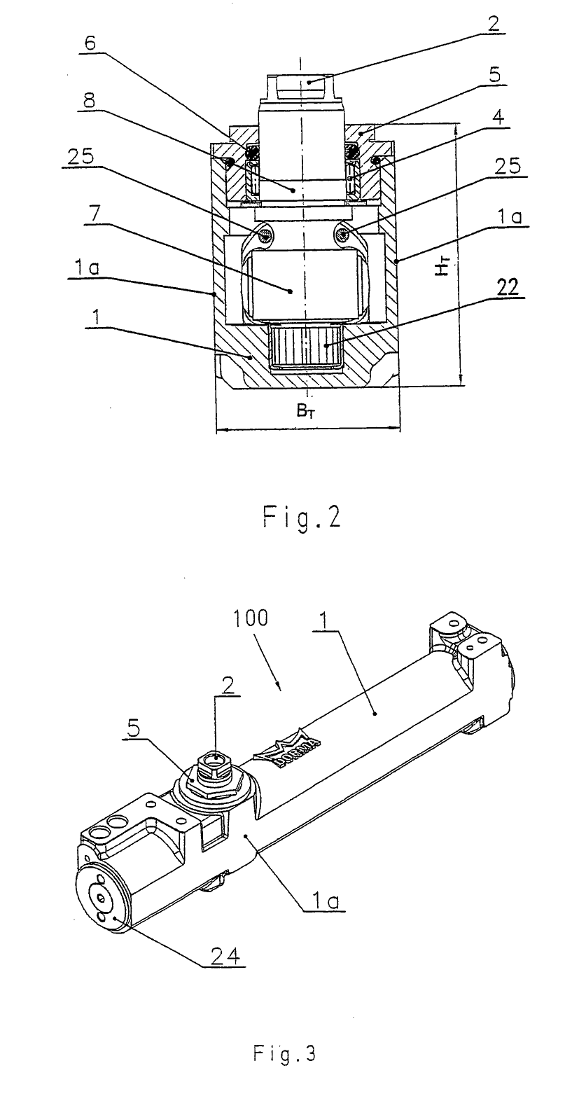

FIG. 2 shows a section along line A-A through the driver square end of the overhead door closer,

FIG. 3 shows a perspective illustration of the overhead door closer,

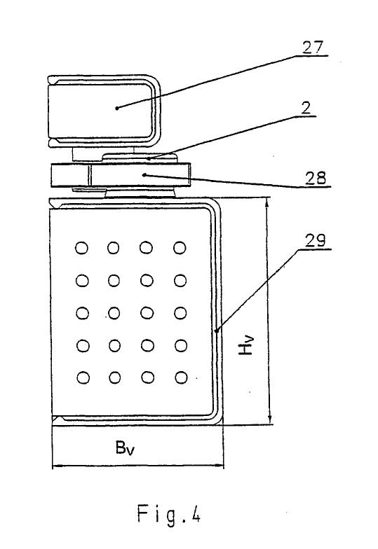

FIG. 4 shows a lateral illustration of the overhead door closer in the mounted state with the casing,

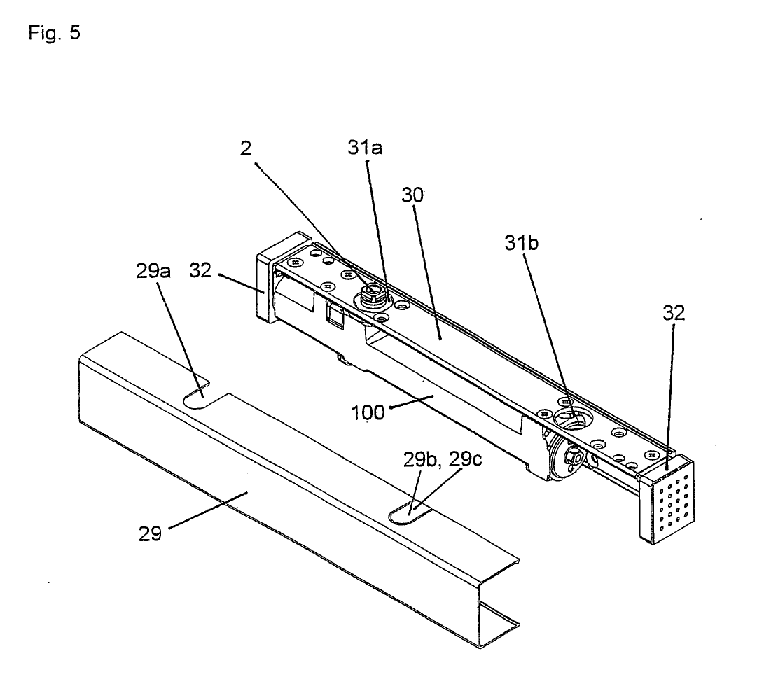

FIG. 5 shows a perspective illustration of the overhead door closer, the casing being removed.

In FIG. 1, an overhead door closer 100 is illustrated, the central component thereof being a cam disc 7. On the right, side of the cam disc 7, the area of the compression springs 12, 13 extends and on the left side a damping device of the overhead door closer with a damping piston 21. The closer shaft 8 is exiting only on one side of the housing 1 with a free end, i.e. the driver square end 2. The end of the closer shaft 22 located inside the housing 1 is located in a bearing 3. Hereby the closer shaft 8 is supported in relation to the housing 1. Furthermore, the closer shaft 8 is supported by a bearing 4, the sealing of the overall closer shaft 8 being realized through a gasket ring 6. The bearing 4 with the gasket ring 6 is located in a bearing ring 5, which represents the closure of the closer shaft 8. A symmetrically or asymmetrically embodied cam disc 7 is located within the housing 1 as a component of the closer shaft 8. This cam disc 7 is in direct contact with a power transmission roller 9 and a roller 19, which, with a symmetrical cam disc, are disposed in the centerline of the housing axis. These rollers 9, 19 are in turn rotatably supported through axle pins 10 and 20. The cam disc 7 is integrally mounted with the closer shaft 8. However, the closer shaft 8 is rotatably supported in the bearings 3 and 4.

The cam disc 7 is already known from the state of the art, which is conceived with its curve paths symmetrical to the centerline of the overhead door closer.

In the symmetrical cam disc 7, the cam paths together form an almost heart-shaped circumferential contour. On account of this symmetrical conception, each mounting type achieves the same torque characteristics with the same closing attenuation.

The power transmission roller 9 surrounds the axle pin 10 within a spring supporting member 11. The exterior compression spring 12, which with its other end bears against an abutment 15, presses against the spring supporting member 11. The abutment 15 is disc-shaped and has a threaded bore in its center, into which the threaded shaft of an adjusting journal 17 engages. The adjusting journal 17 in turn engages in a screwable closing plug 18, which is located at one front side of the housing 1. With the intention to reduce the exterior diameter of the exterior compression spring 12, an inner compression spring 13 is integrated into the inside of the exterior compression spring 12. This interior compression spring 13 acts with its force on a spring supporting member 14, which in turn is supported at the spring supporting member 11 of the exterior compression spring 12. The second support of the interior compression spring 13 is realized via an intermediate piece 16, which is attached at the end of the threaded shaft of the adjusting journal 17. The adjusting journal 17 simultaneously adjusts the spring travel of both springs 12, 13 and thus their force. The interior spring 13 presses the intermediate piece 16 against the adjusting journal 17 and the exterior spring 12 presses an abutment 15 against the adjusting journal 17. The adjusting journal 17, via its shoulder 17a, transmits the force onto a disc 26, which in turn is supported at the closing plug 18. Therefore, all the axial forces are absorbed by the thread 18a of the closing plug 18. This thread 18a has been changed from a regular metric thread to a fine thread, the thread length being increased as well.

The roller 19, which also presses against the cam disc 7, is located within the damping piston 21. A pressure spring 23, which is supported at a closing plug 24 located within the second front side of the housing 1, presses against the damping piston 21.

It is known that part of the spring energy can be dissipated by the rotation of the spring supporting member 11 and of the damping piston 21 in relation to the cam disc 7. In this case, a remedial action is taken by an anti-rotation means, in which the spring supporting member 11 is connected to the damping piston 21 by means of securing pins 25, thus preventing a rotation. This measure as well serves to optimize the dimensions of the exterior spring 12.

Based on the findings that the critical point in dimensioning the overhead door closer are not the bending moments of the housing, which are generated by an induced torque moment onto the driver square end 2, but the support of the springs 12, 13 at the closing plug 18, the overall exterior diameter of the substantially circular ring-shaped cross-section of the housing 1 could be reduced by 4 mm for a door closer size EN 2-4. Additionally, the housing 1 was routed off along the longitudinal axis parallel to the attachment at the wall or at the door, i.e. a segment of the circle was removed on both sides across the cross-section of the housing 1, as shown in the perspective illustration of FIG. 3. The originally circular ring-shaped cross-section of the housing 1, which is similar to a tube, thus receives two housing walls 1a, which have a substantially plane surface on the outside. A width B_{T} of the overhead door closer, corresponding to the distance of the housing walls 1a, has been reduced for a door closer size EN 2-4 to 33 mm or even 31 mm, preferably 32 mm, and a height H_{T} to 46 mm or even 44 mm, preferably 45 mm (FIG. 2).

FIG. 4 is a lateral illustration of the overhead door closer without showing the door and frame. In this mounting situation, the overhead door closer including a casing 29 is attached at the door leaf (not illustrated) and a guiding rail 27 is attached at a door, a door frame or a wall (not illustrated). One end of an actuating arm 28, which with its other end is attached at the guiding rail 27, is attached at the driver square end 2 of the overhead door closer. Once the overhead door closer including the casing is installed, the optimization of the overhead door closer for a door closer size EN 2-4 results in an overall width Bᵥ of a total of 38 mm or even 36 mm, preferably 37 mm, and a height Hᵥ of 50 mm or even 48 mm, preferably 49 mm.

The attachment of the overhead door closer 100 at a mounting bracket 30, which can be mounted directly or indirectly by means of the mounting plate (not illustrated) to the door, the door frame or the wall, is shown in FIG. 5. The mounting bracket 30 has the advantage of improved accessibility when compared to other housing or casing options. The attachment points and the openings 31a, 31b for the driver square end 2 at the mounting bracket 30 are conceived such that an optional mounting to right hinged or left hinged doors can be carried out with one overhead door closer 100 and one mounting bracket 30. Laterally, the mounting bracket 30 is closed by cover caps 32. The casing 29 is just slid onto the mounting bracket 30 with the overhead door closer 100 already mounted in place. The casing 29 is likewise intended for a possible use with right hinged or left hinged doors, because apertures 29a, 29b corresponding to the openings 31a, 31b and to the driver square end 2 can be provided, and can be produced by removing or breaking off covering clips 29c.

### LIST OF REFERENCES

1 housing
1a housing wall
2 driver square end
3 bearing
4 bearing
5 bearing ring
6 gasket ring
7 cam disc
8 closer shaft
9 power transmission roller
10 axle pin
11 spring supporting member
12 compression spring—exterior
13 compression spring—interior
14 spring supporting member
15 abutment
16 intermediate piece
17 adjusting journal
17a a shoulder
18 closing plug
18a a thread
19 roller
20 axle pin
21 damping piston
22 closer shaft end
23 pressure spring
24 closing plug
25 securing pin
26 disc
27 guiding rail
28 actuating arm
29 casing
29a aperture
29b aperture
29c cover clip
30 mounting bracket
31a opening
31b opening
32 cap
100 overhead door closer
B_{T} width of door closer
B_{V} width of casing
H_{T} height of door closer
H_{V} height of casing

1.-6. (canceled)

7. An overhead door closer comprising:
a housing having a longitudinal axis and opposed first and second ends fitted with closing plugs;
a closer shaft journaled for rotation in said housing and having a cam disc fixed thereto inside said housing, said closer shaft having an end fitted with an actuating arm outside said housing;
a longitudinally movable spring supporting member which is fixed against rotation in said housing;
a power transmission roller journaled for rotation relative to said spring supporting member and bearing against said cam disk;
a pair of concentric coil springs comprising an inner compression spring and an outer compression spring supported between said spring supporting member and said closing plug at said first end of said housing;
a damping piston supported against said closing plug at said second end of said housing by a spring; and
a roller journaled for rotation relative to said damping piston and bearing against said cam disk opposite from said power transmission roller.

8. The overhead door closer of claim 7 further comprising securing pins connecting said damping piston to said spring supporting member and passing on either side of said closer shaft, thereby preventing rotation of said damping piston and said spring supporting member relative to said housing.

9. The overhead door closer of claim 7 further comprising an adjusting journal positioned between said compression springs and said closing plug at said first end of said housing.

10. The overhead door closer of claim 7 further comprising a mounting bracket in which said housing can be installed, said housing having a flat outside wall on at least one side of said longitudinal axis.

11. The overhead door closer of claim 10 wherein said housing has a flat outside wall on both sides of said longitudinal axis.

12. The overhead door closer of claim 111 wherein said mounting bracket has a pair of apertures which can receive said end of said closer shaft in either of two orientations of said housing in said bracket.

13. The overhead door closer of claim 12 further comprising a casing which can be fitting to said mounting bracket after said housing is installed, said cover having a pair of openings which align with said apertures in said bracket.

14. The overhead door closer of claim 14 wherein said openings are provided with a pair of respective removable covers, whereby only the cover corresponding to the end of the closer shaft needs to be removed.

15. The overhead door closer of claim 13 wherein the width of the overhead door closer including the bracket and the casing is 36-38 mm.

16. The overhead door closer of claim 7 wherein said closing plug at said first end of said housing has a fine thread.
